(19) United States
(12) Patent Application Publication
(10) Pub. No.: US 2019/0285239 A1
(43) Pub. Date: Sep. 19, 2019

(54) Lighting Apparatus for a Motor Vehicle

(71) Applicant: Bayerische Motoren Werke Aktiengesellschaft, Muenchen (DE)

(72) Inventors: Helmut ERDL, Flintsbach (DE); Abdelmalek HANAFI, Muenchen (DE)

(21) Appl. No.: 16/428,120

(22) Filed: May 31, 2019

Related U.S. Application Data
(63) Continuation of application No. PCT/EP2018/054131, filed on Feb. 20, 2018.

(30) Foreign Application Priority Data
Mar. 9, 2017 (DE) 10 2017 203 891.8

(51) Int. Cl. F21S 41/16; F21S 41/675; F21S 41/20; F21S 43/13; F21S 43/30; F21S 43/20; B60Q 1/04; B60Q 1/44

(52) U.S. Cl. CPC F21S 41/16; F21S 41/675; F21S 41/285; F21S 43/13; B60Q 2400/50; F21S 43/26; B60Q 1/04; B60Q 1/44; F21S 43/30

(57) ABSTRACT

A lighting apparatus for a motor vehicle has a lighting module. The lighting module includes a laser light source for generating laser light, the laser light source having one or more laser diodes. The module includes an optical device onto which the laser light is incident and which is designed such that it generates a predefined symbol in the surroundings of the motor vehicle. The optical device has one or more holographic optical elements which are substantially non-absorbent to the laser light and which are designed to effect interference of the laser light by phase modulation thereof in order to generate the predefined symbol. The module includes an actuator system for moving at least one part of the lighting module. The actuator system has one or more actuators. A control device actuates the actuator system during operation of the illuminating device such that the position of the predefined symbol relative to the motor vehicle and/or the shape of the predefined symbol are changed by the actuator system.

### CROSS REFERENCE TO RELATED APPLICATIONS

This application is a continuation of PCT International Application No. PCT/EP2018/054131, filed Feb. 20, 2018, which claims priority under 35 U.S.C. § 119 from German Patent Application No. 10 2017 203 891.8, filed Mar. 9, 2017, the entire disclosures of which are herein expressly incorporated by reference.

This application contains subject matter related to U.S. application Ser. No. ______ (Atty Docket No. 080437.PC261US), entitled “Lighting Apparatus for a Motor Vehicle” filed on even date herewith.

### BACKGROUND AND SUMMARY OF THE INVENTION

The invention relates to a lighting apparatus for a motor vehicle and also to a corresponding motor vehicle.

Approaches according to which symbols are projected onto the ground in the area surrounding a motor vehicle by means of a light module are known from the prior art. The problem with said approaches is that the range of light modules of said kind is limited. Furthermore, light modules of this kind generally generate symbols of which the position and form are static. Accordingly, the symbols produced using these light modules are suitable for driver assistance and/or for communication with other road users (for example as warning signals) only to a limited extent.

The object of the invention is therefore to provide a lighting apparatus for a motor vehicle comprising a light module with which a readily perceivable symbol arrangement can be generated at a relatively large distance from the motor vehicle.

The lighting apparatus according to the invention is intended for a motor vehicle, in particular a passenger car and possibly also a truck. The lighting apparatus comprises a light module which will be described in more detail below. The lighting apparatus may possibly also have a plurality of light modules of this kind. The light module contains a laser light source for generating laser light, wherein the laser light source comprises one or more laser diodes. In this case, the power of the respective laser diodes is between 200 mW and 300 mW, but may possibly also be higher and be up to 3 to 4 watts. The laser light source preferably produces one or more collimated beams of laser light.

If, in the text which follows and in particular in the patent claims, interactions between the lighting apparatus and the motor vehicle are described, this is always intended to be understood to mean that the interaction occurs when the lighting apparatus is arranged or installed in the motor vehicle. The components of the lighting apparatus which are in corresponding interaction with the motor vehicle or components of the motor vehicle are therefore configured in such a way that the interaction is caused when the lighting apparatus is arranged or installed in the motor vehicle.

The light module of the lighting apparatus according to the invention contains an optical device on which the laser light which is generated by the laser light source is incident and which is configured in such a way that it generates a predefined symbol arrangement in the area surrounding the motor vehicle, preferably on the ground, when the lighting apparatus in the motor vehicle is in operation. The optical device comprises one or more holographic optical elements which are substantially non-absorbent to the laser light and which are designed to cause interference of the laser light by means of phase modulation thereof in order to generate the predefined symbol arrangement. In this case, the term “non-absorbent” is intended to be understood in such a way that the laser light has an intensity of 95% or more and in particular of 99% or more and particularly preferably of 100% after passing the holographic optical element or elements in comparison to the intensity before passing the holographic optical element or elements. Depending on the embodiment, the holographic elements can respectively be reflective or transmissive elements.

The above term “the symbol arrangement” is intended to be understood in such a way that it comprises one or more symbols which can be perceived by a human. In particular, the symbols can be perceived by the driver and/or an occupant of the motor vehicle or else also road users in the area surrounding motor vehicle. In a preferred variant, the symbol arrangement comprises one or more arrows and/or one or more lines. Depending on the refinement, the symbol arrangement can comprise one or more white and/or one or more colored symbols.

The above term “the area surrounding the motor vehicle” is intended to be understood in a broad sense and can correspond, in particular, to the range of a high beam or low beam of the headlamp of the motor vehicle. As described further below, the light module can also be installed in a headlamp of the motor vehicle. If, in this case, the symbol arrangement is superimposed with the headlamp light of the motor vehicle, it is so bright that it is still visible even in the headlamp light.

The light module of the lighting apparatus according to the invention further contains an actuator system for moving at least a portion of the light module, wherein the actuator system comprises one or more actuators for this movement. Furthermore, the light module includes a control device with which the actuator system is actuated during operation of the lighting apparatus in such a way that the position of the predefined symbol arrangement relative to the motor vehicle and/or the form of the predefined symbol arrangement are changed by way of the actuator system. In this case, changing the position and/or form of the symbol arrangement does not have to take place permanently during operation of the lighting apparatus, but rather can be linked to a particular operating mode or other conditions. The control device is preferably further configured in such a way that it controls the processes of switching on and switching off the light module. If a plurality of light modules are provided in the lighting apparatus, said light modules can optionally use a single common control device for controlling the actuator systems.

The invention is distinguished in that a dynamic symbol arrangement is produced in a lighting apparatus for a motor vehicle by means of phase-modulated holographic optical elements. Holographic optical elements of this kind are known per se and are distinguished in that the structures for deflecting the light are in the region of the wavelength of said light, so that diffraction effects occur. According to the invention, this ensures that the laser light is coherent when passing the holographic optical elements, so that the light can interfere.

The lighting apparatus according to the invention has the advantage that a dynamic light function can be provided by way of a symbol arrangement in a simple manner owing to the use of phase-modulated holographic optical elements in combination with a controlled actuator system, the position of said symbol arrangement in relation to the motor vehicle or the form of said symbol arrangement being changed. As a result, the symbol arrangement can be perceived very easily. Furthermore, a sufficient degree of brightness of the symbol arrangement is also ensured since the holographic optical elements are substantially non-absorbent to the laser light.

In a preferred variant of the lighting apparatus according to the invention, the holographic optical element or elements comprise one or more diffractive optical elements which are known per se.

In a further refinement, the total surface area of the holographic optical elements in plan view is between 100 mm² and 900 mm², in particular between 300 mm² and 600 mm². Owing to the use of holographic optical elements of this kind, the laser light is distributed over a surface region, as a result of which a sufficient degree of eye safety is ensured.

In a further preferred embodiment, the light module is configured in such a way that the laser light of the laser light source is directed to the optical device with the interposition of one or more optical fibers, as a result of which flexible installation of the light module in the lighting apparatus is rendered possible. Nonetheless, it is also possible for the laser light to be directed to the optical device without the interposition of optical fibers of this kind.

In a further particularly preferred embodiment, the lighting apparatus comprises, in addition to the light module, a light device in order to generate a predefined light distribution in addition to the symbol arrangement. In other words, the symbol arrangement is generated at the same time as the predefined light distribution is produced. In this case, the lighting apparatus is preferably a headlamp or comprises a headlamp, wherein, in this case, the light device is designed to generate low beam and/or high beam distribution as predefined light distribution. Nonetheless, it is also possible for the lighting apparatus to comprise a vehicle signaling lamp, such as a rear light and/or a brake light for example. In this case, the light device is designed to generate a light signal as predefined light distribution.

In a preferred variant of the above embodiments which comprise a light device in addition to the light module, when the light device is switched on and the light module is switched on, the predefined symbol arrangement is superimposed with the predefined light distribution. Therefore, the symbol arrangement is configured in such a way that it is visible in spite of the additional light distribution and can be distinguished from said additional light distribution. If the lighting apparatus is a headlamp which emits white headlamp light, the symbol arrangement preferably also has a white color. If, however, the lighting apparatus emits monochromatic light, the color of the symbol arrangement preferably also corresponds to the color of this light. Statutory provisions are taken into account in this way.

In a further variant, the lighting apparatus according to the invention is configured in such a way that the light module can be switched on only when the light device is switched on, it being possible for this to be achieved using the control device in the lighting apparatus according to the invention. Appropriate statutory provisions are taken into account with this variant too.

In a further preferred embodiment of the lighting apparatus according to the invention, the optical device comprises at least one mirror on which the laser light is incident after passing the holographic optical element or elements, wherein the at least one mirror can be moved by way of at least one predefined actuator of the actuator system by way of the actuation by the control device. In other words, the change in the form and/or position of the symbol arrangement is achieved by moving the mirror. The form and/or position of the symbol arrangement can be influenced in a very flexible manner using a mirror of this kind.

In a preferred variant of the above embodiment, the at least one predefined actuator is designed to execute an oscillating movement during operation of the lighting apparatus, wherein the path of the oscillating movement describes the form of the predefined symbol arrangement. Therefore, a pattern which corresponds to the form of the predefined symbol arrangement is followed with an oscillating scanning movement. The frequency of the oscillating movement is preferably of such a magnitude that the movement is no longer perceivable to the human eye. The path and/or the speed of the oscillating movement of the at least one mirror is preferably freely adjustable. In this sense, the mirror forms a vector scanner which can follow any desired pattern, in contrast to conventional scanners. In this way, the form of the predefined symbol arrangement can be adapted in a very flexible manner.

In a further preferred refinement of the lighting apparatus according to the invention, at least one predetermined actuator of the actuator system is provided in such a way that it produces a relative movement, preferably an oscillating relative movement, between the holographic optical element or elements and the laser light before passing the holographic optical element or elements during operation of the lighting apparatus by way of the actuation by the control device, as a result of which light is alternately shone onto different holographic optical structures which are constituent parts of the holographic optical element or elements. The effect of a moving symbol for a changeover between different symbols can be achieved in this way.

Depending on the configuration of the above embodiment, only the holographic optical element or elements or only the laser light source or both the holographic optical element or elements and also the laser light source can be moved by the at least one predetermined actuator.

In a particularly preferred embodiment of the lighting apparatus according to the invention which constitutes, in particular, a headlamp, the laser light source is an RGB laser light source which comprises a number of (that is to say one or more) red laser diodes, a number of (that is to say one or more) green laser diodes and a number of (that is to say one or more) blue laser diodes as laser diodes. The wavelengths which are usually employed in RGB light systems are used as wavelengths for the light of the individual laser diodes. The red laser light preferably has a wavelength of between 610 nm and 760 nm, the green light preferably has a wavelength of between 500 nm and 750 nm, and the blue laser light preferably has a wavelength of between 450 nm and 500 nm.

In the above lighting apparatus with an RGB laser light source, a first holographic optical structure on which (preferably only) the red laser light of the number of red laser diodes is incident is associated with the number of red laser diodes, whereas a second holographic optical structure on which (preferably only) the green laser light of the number of green laser diodes is incident is associated with the number of green laser diodes. Furthermore, a third holographic optical structure on which (preferably only) the blue laser light of the diodes is incident is associated with the number of blue laser diodes. In this case, the first, second and third holographic optical structures are constituent parts of the holographic optical element or elements. In this embodiment, the light module is configured in such a way that the red, green and blue laser light is superimposed after passing the first, second and third holographic optical structures and as a result the symbol arrangement is generated in white light.

If the position and/or form of the symbol arrangement are/is produced by means of a relative movement between the holographic optical element or elements and the laser light before passing said holographic optical element or elements in the embodiment just described, a plurality of corresponding first and, respectively, second and, respectively, third holographic optical structures are preferably associated with each laser diode, wherein the laser light of the respective laser diodes changes over between different first and, respectively, second and, respectively, third holographic optical structures at the same time.

In a further variant of the lighting apparatus according to the invention, the optical device comprises, in addition to the holographic optical element or elements, one or more further optical elements which follow the holographic optical element or elements, in particular one or more lenses and/or mirrors, in the beam path of the laser light.

In a further preferred embodiment of the lighting apparatus according to the invention, the control device is designed to receive information from a surrounding area sensor system and/or a navigation system of the motor vehicle and to actuate the actuator system depending on this information. The surrounding area sensor system may be, for example, a camera-based sensor system or possibly a radar and/or lidar sensor system or a combination of different sensor systems.

In a preferred variant of the embodiment just described, the control device is configured in such a way that it derives the course of the roadway in front of the motor vehicle from the information of the surrounding area sensor system and matches the form of the predefined symbol arrangement to the course of the roadway, wherein the predefined symbol arrangement preferably comprises one or more lines, the form of said lines being matched to the curvature of the course of the roadway. This variant of the invention is preferably combined with the above-described oscillating mirror in which the course of the oscillating movement describes the form of the predefined symbol arrangement.

In a further variant of the invention, the control device is configured in such a way that it outputs a turn-off instruction as a predefined symbol arrangement based on the information of the navigation system when the motor vehicle is approaching a junction on a navigation route along which the navigation system is currently navigating. In this case, the turn-off instruction signals continued travel on the navigation route. The turn-off instruction is arranged at the site of the junction and maintains this position as the motor vehicle approaches. The turn-off instruction therefore changes its position relative to the motor vehicle but remains static at the junction for the driver of the motor vehicle. As a result, a navigation instruction is provided in a highly intuitive manner to the driver of the motor vehicle as said motor vehicle approaches the junction.

In a further preferred embodiment, the control device is configured in such a way that the light module is switched on when one or more objects, preferably one or more objects at a minimum distance from the motor vehicle, are detected by the surrounding area sensor system. The lighting apparatus can be used, in particular, in combination with a driver assistance system of the motor vehicle. In this case, the symbol arrangement can display, for example by means of lines in front of the vehicle, the width of the roadway. Similarly, a collision warning which warns the occupants of the motor vehicle and/or other road users when a distance from the other road users is undershot, can be displayed by means of the symbol arrangement.

In addition to the above-described lighting apparatus, the invention relates to a motor vehicle which comprises one or more of said lighting apparatuses. Depending on the refinement, said motor vehicle may be a manually controlled motor vehicle, but may also be a self-driving motor vehicle. In the case of a self-driving motor vehicle, the symbol arrangement serves primarily to instruct or warn other road users in the area of the self-driving motor vehicle.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration which shows a first embodiment of a light module in a lighting apparatus according to the invention.

FIG. 2 is a schematic illustration which shows a second embodiment of a light module in a lighting apparatus according to the invention.

FIG. 3 and FIG. 4 show different plan views of motor vehicles comprising the lighting apparatus according to the invention, wherein the generation of different symbol arrangements is illustrated.

### DETAILED DESCRIPTION OF THE DRAWINGS

One embodiment of the invention will be described below using a lighting apparatus in the form of a front headlamp of a motor vehicle. The front headlamp contains, in a manner which is known per se, a light device with which the low beam and the high beam are generated, wherein said light device is not shown in the figures. In addition to this light device, a light module is installed in the headlamp, which light module can generate a specific symbol arrangement on the road in front of the motor vehicle in parallel to the low beam or high beam.

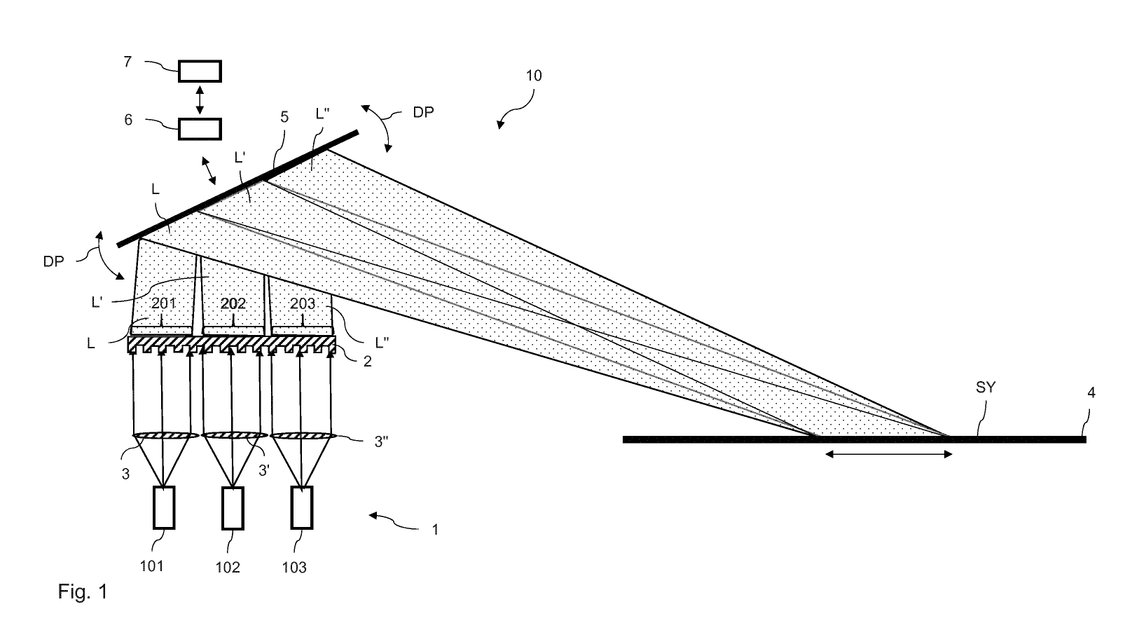

FIG. 1 shows a first embodiment of a light module of this kind. The light module is denoted by reference symbol 10 overall and, in the embodiment described here, comprises a laser light source 1 with three laser diodes 101, 102 and 103 and also three collimator lenses 3, 3′, 3″. The laser diode 101 is a red laser diode, the laser diode 102 is a green laser diode, and the laser diode 103 is a blue laser diode. The light of the respective laser diodes is indicated by arrows which start from said diodes. The laser light of the individual diode is initially collimated by the collimator lenses 3, 3′ and 3″. In this case, the collimator lens 3 collimates the red laser light of the laser diode 101, the collimator lens 3′ collimates the green laser light of the laser diode 102, and the collimator lens 3″ collimates the blue laser light of the laser diode 103. The collimated laser light beams are then incident on the merely schematically indicated transmissive holographic optical element 2. Owing to the structuring on the bottom side of the element, phase modulation and interference of the incident laser beams is produced in the process.

In the embodiment described here, a single continuous holographic optical element 2 which has corresponding holographic optical structures 201, 202 and 203 for the different laser light beams is used. In this case, the red laser light beam is incident on the holographic optical structure 201, the green laser light beam is incident on the holographic optical structure 202, and the blue laser light beam is incident on the holographic optical structure 203. In FIG. 1, the red laser light beam is denoted by reference symbol L after passing the structure 201, the green laser light beam is denoted by reference symbol L′ after passing the structure 202, and the blue laser light beam is denoted by reference symbol L″ after passing the structure 203.

The light beams L, L′ and L″ are initially incident on a tiltable mirror 5, wherein the tilting movement is schematically indicated by two double-headed arrows DP. An actuator 6, merely schematically indicated, is used for generating the tilting of the mirror 5. In this case, the mirror and the actuator can form a so-called MEMS component (MEMS=Micro Electro Mechanical System). In a component of this kind, the mirror and the actuator are integrated in a common chip. The actuator 6 is actuated by a control device 7, that is to say the actuator moves the mirror 5 depending on corresponding control signals of the control device 7. In the embodiment described here, the mirror 5 forms, in combination with the actuator 6 and the control device 7, a vector scanner which can execute an oscillating movement of the mirror, wherein the form of the oscillating movement and the speed thereof can be adjusted as desired. In this case, the vector scanner can also execute slow continuous movements and assume any desired tilting positions in line with the possible tilting of the mirror. The laser light beams L, L′ and L″ which are reflected at the mirror 5 are cast onto the road 4 in front of the motor vehicle.

The structures 201 to 203 of the holographic optical element 2 are configured in such a way that the individual light beams L, L′ and L″ produce the same symbol arrangement at the same point on the road 4, so that a superimposed symbol arrangement SY appears in white at this point. In this case, the brightness of the symbol arrangement is greater than the brightness of the low beam or high beam, so that the symbol arrangement is distinguished from the low beam and high beam and therefore is visible to the driver of the motor vehicle and, respectively, to other road users. In the embodiment of FIG. 1, the phase-modulated laser light which is reflected by the mirror 5 is cast directly onto the road 4. However, if desired, yet further optical elements, such as one or more lenses for example, can also be provided in the beam path downstream of the mirror.

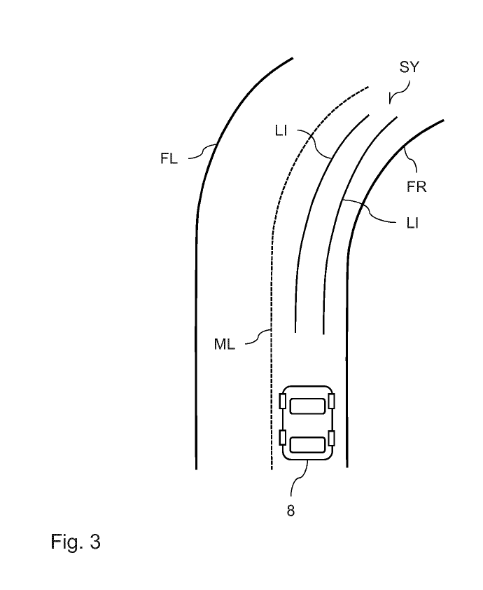

In the embodiment of FIG. 1, the symbol arrangement SY can be positioned at different points by changing the tilting of the mirror 5, and dynamic light effects are produced in this way. However, the symbol arrangement can possibly also be produced by a predefined scanning movement of the three superimposed light beams L, L′ and L″, wherein the movement of the light beams can no longer be perceived by the human eye given a sufficient oscillation frequency. In this way, lines, for example, can be produced as the symbol arrangement, it being possible for the curvature of said lines to be adapted in a suitable manner by changing the scanning movement of the mirror 5. A symbol arrangement which is produced by means of a scanning movement is shown in FIG. 3 which is described further below.

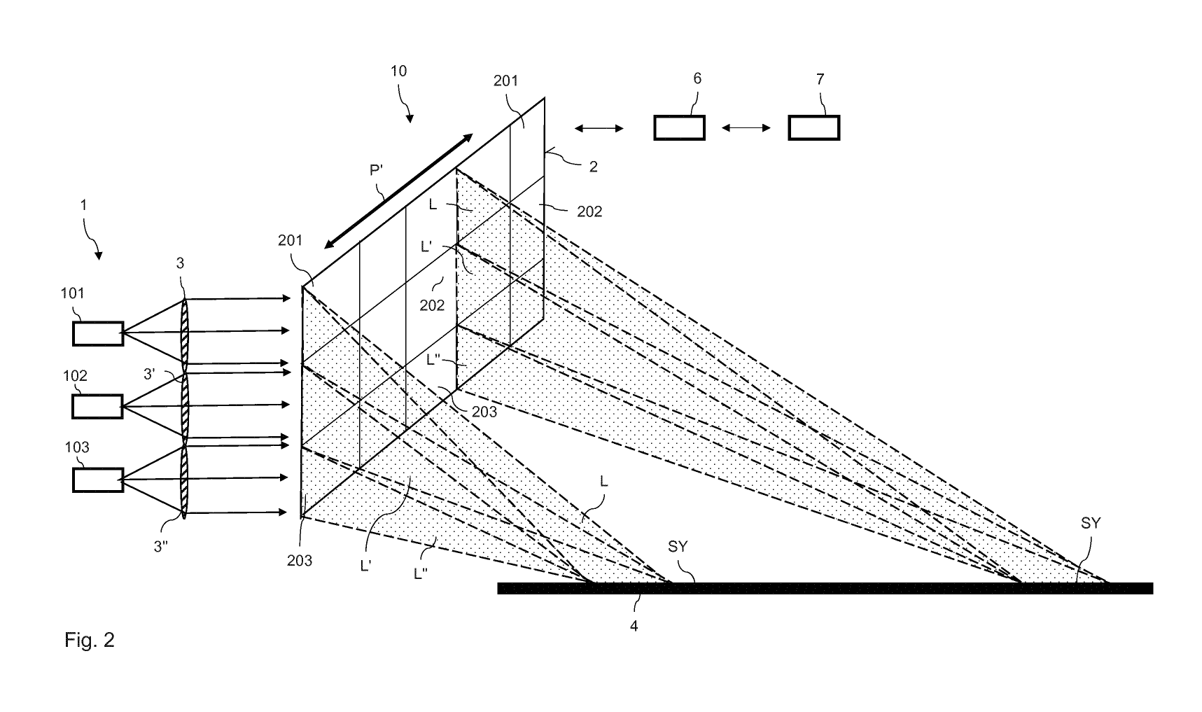

FIG. 2 shows a second variant of a light module 10 which can be used in the lighting apparatus according to the invention. In this case, the structure of the laser light source 1 having corresponding laser diodes 101 to 103 and collimator lenses 3 to 3″ corresponds to the laser light source from FIG. 1, and therefore reference is made to the explanations relating to said figure. In contrast to FIG. 1, the holographic optical element 2 is now not formed only from three holographic optical elements 201 to 203, but rather from a matrix of a total of 15 holographic optical structures, wherein the holographic optical element 2 is shown in perspective for the purpose of illustrating said matrix. The matrix-like holographic optical element contains, in the first row, five holographic optical structures 201 which differ from one another and can be illuminated only by the laser light of the red laser diode 101. In contrast, the second row of the matrix comprises the five holographic structures 202 which can be illuminated only by the green laser diode 102 and differ from one another. Analogously, the lowermost row of the matrix comprises the five holographic optical structures 203 which differ from one another and can be illuminated only by the blue laser diode 103. For reasons of clarity, only some of the holographic optical structures are denoted by the reference symbols 201, 202 and 203.

In the embodiment of FIG. 2, the holographic optical element 2 can be moved by means of a corresponding actuator 6 which, in turn, can be actuated by way of a control device 7. In this case, the holographic optical element 2 can be shifted in the horizontal direction, as is indicated by the arrow P′. In this way, the laser light source can illuminate different columns of holographic optical structures 201 to 203. When illuminating a corresponding column of holographic optical structures, the three laser light colors are phase-modulated, in response to which the red laser light beam L, the green laser light beam L′ and the blue laser light beam L″ are directed onto a common point on the road 4 and are superimposed there to form a white symbol arrangement SY. In FIG. 2, this superimposition is indicated, by way of example, for the illumination of the left-hand-side column of the holographic optical structures 201 to 203 and also the fourth column from the left of the holographic optical structures. The holographic optical structures of the individual columns each produce the same symbol arrangement SY, but in a different position on the road 4.

By way of the embodiment of FIG. 2, the symbol arrangement SY can be shifted to and fro between different positions on the road 4 in front of the motor vehicle. In this case, a periodic movement of the holographic optical element 2 can also be optionally carried out, so that a continuous change in the position of the symbol arrangement on the road is achieved, as a result of which the symbol arrangement is better perceived by the driver or other road users.

In the embodiment of FIG. 2, a relative movement between the laser light source 1 and the holographic optical element 2 was produced only by the movement of the holographic optical element. Nonetheless, it is also possible for this relative movement to be generated only by the movement of the laser light source 1 or by simultaneous movement of the laser light source 1 and of the holographic optical element 2 by way of another actuator or further actuators.

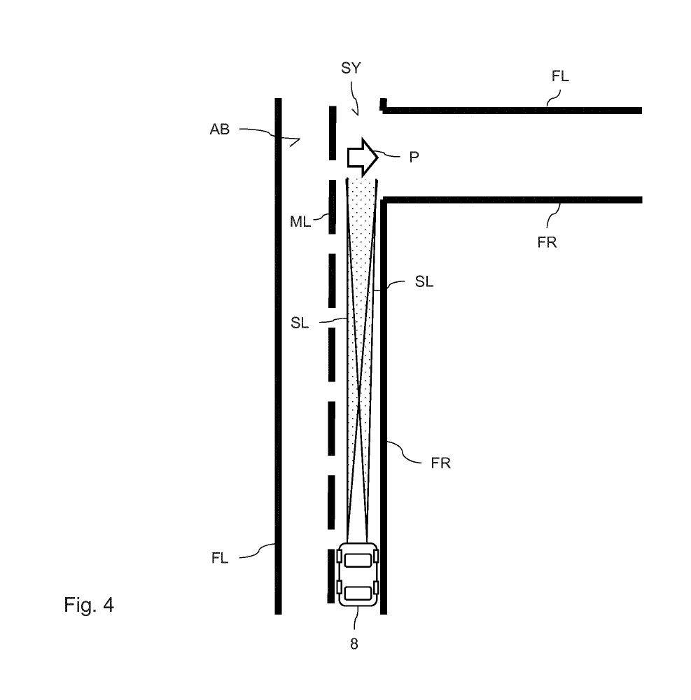

FIG. 3 and FIG. 4 illustrate, by way of example, what types of symbols can be generated by means of the lighting apparatus according to the invention. Both figures show different plan views of a motor vehicle 8 which is traveling on a right-hand-side lane on a roadway. The direction of travel is the upward direction in FIG. 3 and FIG. 4. In the two figures, the right-hand-side roadway edge is denoted by reference symbol FR, the left-hand-side roadway edge is denoted by reference symbol FL, and the central strip is denoted by reference symbol ML. In this case, the individual symbol arrangements generated are optionally generated by a light module according to the invention in the left-hand-side front headlamp and a light module according to the invention in the right-hand-side front headlamp of the motor vehicle 8.

FIG. 3 shows the generation of a symbol arrangement in the form of two solid lines LI. This symbol arrangement is generated by means of the scanning light module of FIG. 1, wherein the form of the lines is specified by the scanning movement of the scanning mirror. As shown in FIG. 3, the lines LI depict the course of the roadway in front of the motor vehicle. In order to achieve this, the control device of the corresponding light modules receives sensor signals from a surrounding area sensor system of the motor vehicle 8, which surrounding area sensor system detects the future course of the motor vehicle on the roadway. In this case, the surrounding area sensor system is preferably a camera-based sensor system. By means of the sensor signals of the surrounding area sensor system, the two lines LI are then generated in such a way that they follow the future course of the roadway. Since the course of the roadway in FIG. 3 is curved, this also leads to curved lines being represented.

FIG. 4 shows a scenario in which a turn-off arrow P is represented on the roadway at a junction AB as a symbol. Said arrow is preferably also generated by the light module of FIG. 1, wherein in this case the mirror does not oscillate but rather slowly changes its tilting position. In this case, the arrow P corresponds to the symbol arrangement which results from superimposing the three laser light beams L, L′ and L″ of FIG. 1. For illustrative purposes, the light of the two headlamps is further shown in FIG. 4 and denoted by corresponding reference symbol SL.

In the embodiment of FIG. 4, the control device of the corresponding light modules receives, from the navigation system of the motor vehicle 8, information relating to the currently set navigation route and the position of the motor vehicle on this route. In this case, the control system identifies that the motor vehicle is approaching the junction AB and, according to the navigation route, the journey should continue toward the right at the junction. As a consequence, the arrow P toward the right is generated in the position of the junction AB. As the vehicle continues to approach the junction AB, said arrow is constantly held in this position by means of the actuator system in the light module. In other words, a relative movement between the arrow P and the motor vehicle 8 is carried out in such a way that the arrow P remains at the site of the junction AB until the vehicle reaches the junction. In this way, the driver of the motor vehicle is intuitively informed about which direction he has to take at the junction as the vehicle approaches the junction.

The embodiments of the invention described above have a range of advantages. In particular, a predefined symbol arrangement can be generated in the area surrounding the motor vehicle by a motor vehicle lighting apparatus in a simple manner by means of one or more non-absorbent holographic optical elements. In this case, the holographic optical elements cause phase modulation, without reducing the light amplitude by absorption, so that largely no light losses occur. In this case, sufficient brightness of the symbol arrangement is ensured by means of a laser light source. Furthermore, the symbol arrangement is provided with a degree of dynamism by means of the actuator system and a control device to the effect that the symbol arrangement can change its form and/or position. In particularly preferred embodiments, the generation of the symbol arrangement is linked to information from a navigation system or a surrounding area sensor system. Owing to the use of information of a navigation system, the driver can be provided with turn-off instructions in a dynamic manner for example. When using information of a surrounding area sensor system, the course of the roadway in front of the motor vehicle for example can be displayed by means of the symbol arrangement.

### LIST OF REFERENCE SYMBOLS

1 Laser light source
101, 102, 103 Laser diodes
2 Holographic optical element
201, 202, 203 Holographic optical structures
3, 3′, 3″ Collimator lenses
4 Road
5 Mirror
6 Actuator
7 Control device
8 Motor vehicle
L, L′, L′ Laser light beams
SY Symbol arrangement
DP Double-headed arrows
FL, FR Roadway edges
ML Central strip
LI Lines
P, P′ Arrows
AB Junction
SL Headlamp light

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A lighting apparatus for a motor vehicle, comprising:
a light module, wherein the light module comprises:
a laser light source for generating laser light, wherein the laser light source comprises one or more laser diodes;
an optical device on which the laser light is incident and which is configured such that the optical device generates a predefined symbol arrangement in an area surrounding the motor vehicle, wherein the optical device comprises one or more holographic optical elements which are substantially non-absorbent to the laser light and which are configured to produce interference of the laser light by phase modulation thereof in order to generate the predefined symbol arrangement;
an actuator system for moving at least a portion of the light module, wherein the actuator system comprises one or more actuators; and
a control device with which the actuator system is actuated during operation of the lighting apparatus such that a position of the predefined symbol arrangement relative to the motor vehicle and/or a form of the predefined symbol arrangement are changed via the actuator system.

2. The lighting apparatus according to claim 1, wherein
the one or more holographic optical elements comprise one or more diffractive optical elements.

3. The lighting apparatus according to claim 1, further comprising:
a light device that generates a predefined light distribution in addition to the predefined symbol arrangement.

4. The lighting apparatus according to claim 3, wherein
the light device is a headlamp configured to generate low beam and/or high beam distribution as the predefined light distribution, and/or the light device is a vehicle signaling lamp configured to generate a light signal as the predefined light distribution.

5. The lighting apparatus according to claim 4, wherein
the vehicle signaling lamp is a rear light and/or a brake light.

6. The lighting apparatus according to claim 3, wherein
when the light device is switched on and the light module is switched on, the predefined symbol arrangement is superimposed with the predefined light distribution.

7. The lighting apparatus according to claim 1, wherein
the optical device comprises at least one mirror on which the laser light is incident after passing the one or more holographic optical elements, and
the at least one mirror is movable by at least one predefined actuator of the actuator system by way of actuation by the control device.

8. The lighting apparatus according to claim 7, wherein
the at least one predefined actuator is configured to execute an oscillating movement of the at least one mirror during operation of the lighting apparatus, wherein a path of the oscillating movement describes the form of the predefined symbol arrangement.

9. The lighting apparatus according to claim 8, wherein
the path and/or a speed of the oscillating movement of the at least one mirror are freely adjustable.

10. The lighting apparatus according to claim 1, wherein
at least one predetermined actuator of the actuator system is provided so as to produce a relative movement between the one or more holographic optical elements and the laser light before passing the one or more holographic optical elements during operation of the lighting apparatus by way of actuation by the control device, as a result of which light is alternately shone onto different holographic optical structures which are constituent parts of the one or more holographic optical elements.

11. The lighting apparatus according to claim 10, wherein
the relative movement is an oscillating relative movement.

12. The lighting apparatus according to claim 10, wherein
only the one or more holographic optical elements, only the laser light source, or both the one or more holographic optical elements and the laser light source, are movable by the at least one predetermined actuator.

13. The lighting apparatus according to claim 1, wherein
the laser light source is an RGB laser light source which comprises a number of red laser diodes, a number of green laser diodes and a number of blue laser diodes,
a first holographic optical structure on which the red laser light of the number of red laser diodes is incident is associated with the number of red laser diodes, a second holographic optical structure on which the green laser light of the number of green laser diodes is incident is associated with the number of green laser diodes, and a third holographic optical structure on which the blue laser light of the diodes is incident is associated with the number of blue laser diodes,
the first, second and third holographic optical structures are constituent parts of the one or more holographic optical elements, and
the light module is configured such way that the red, green and blue laser light is superimposed after passing the first, second and third holographic optical structures and as a result the predefined symbol arrangement is generated in white light.

14. The lighting apparatus according to claim 1, wherein
the control device is configured to receive information from a surrounding area sensor system and/or a navigation system of the motor vehicle and to actuate the actuator system depending on said information.

15. The lighting apparatus according to claim 14, wherein
the control device is configured to extract or ascertain a course of a roadway in front of the motor vehicle from said information of the surrounding area sensor system and match the form of the predefined symbol arrangement to the course of the roadway.

16. The lighting apparatus according to claim 15, wherein
the predefined symbol arrangement comprises one or more lines, the form of said lines being matched to a curvature of the course of the roadway.

17. The lighting apparatus according to claim 14, wherein
the control device is configured to output a turn-off instruction as a predefined symbol arrangement based on the information of the navigation system when the motor vehicle is approaching a junction on a navigation route along which the navigation system is currently navigating, and
the turn-off instruction signals continued travel on the navigation route and wherein the turn-off instruction is arranged at a site of the junction and maintains this position as the motor vehicle approaches.

18. A motor vehicle comprising one or more lighting apparatuses according to claim 1.
